(19) United States
(12) Patent Application Publication
(10) Pub. No.: US 2017/0015860 A1
(43) Pub. Date: Jan. 19, 2017

(54) ANTI-FOGGING AGENT COMPOSITION, ANTI-FOGGING ARTICLE AND MANUFACTURING METHOD THEREOF

(71) Applicant: Asahi Glass Company, Limited, Chiyoda-ku (JP)

(72) Inventors: Hirokazu KODAIRA, Chiyoda-ku (JP); Yosuke SUGIHARA, Chiyoda-ku (JP); Yusuke MORI, Chiyoda-ku (JP); Takashige YONEDA, Chiyoda-ku (JP)

(73) Assignee: Asahi Glass Company, Limited, Chiyoda-ku (JP)

(21) Appl. No.: 15/277,224

(22) Filed: Sep. 27, 2016

Related U.S. Application Data
(63) Continuation of application No. PCT/JP2015/059624, filed on Mar. 27, 2015.

(30) Foreign Application Priority Data
Apr. 1, 2014 (JP) 2014-075762

(51) Int. Cl. C09D 163/00; C09D 7/12; C08L 63/00

(52) U.S. Cl. CPC C09D 163/00; C08L 63/00; C09D 7/1233

(57) ABSTRACT

An antifogging agent composition excellent in an antifogging property and peel resistance and an antifogging article obtained using it are provided. The antifogging agent composition includes: a first resin having a water-soluble rate of 90% or more; a second rein having a water-soluble rate of 50% or less; an alkoxysilane compound; and a curing agent, wherein the first resin is a polyfunctional aliphatic epoxy resin, and the second resin is a polyfunctional aromatic epoxy resin having a water-soluble rate of less than 20%. Further, the antifogging article includes: a substrate; and a cured product of the antifogging agent composition, disposed in at least a part of a region on the substrate. Further, a manufacturing method of an antifogging article includes: forming an antifogging agent composition layer by applying the antifogging agent composition on a substrate; and forming an antifogging layer by heat-treating the applied antifogging agent composition.

### CROSS-REFERENCE TO RELATED APPLICATIONS

This application is a continuation of prior International Application No. PCT/JP2015/059624, filed on Mar. 27, 2015 which is based upon and claims the benefit of priority from Japanese Patent Application No. 2014-075762, filed on Apr. 1, 2014; the entire contents of all of which are incorporated herein by reference.

### FIELD

The present invention relates to an antifogging agent composition, and an antifogging article obtained using it and a manufacturing method thereof.

### BACKGROUND

Regarding a transparent substrate such as glass or plastic, when a substrate surface is at a temperature of dew-point or lower, minute water droplets adhere to the surface to scatter transmitted light, which impairs transparency, resulting in a so-called “fogging” state. As means for preventing fogging, various proposals have been made hitherto.

In Patent Reference 1 (International Publication WO 2007/052710), there is proposed an antifogging article having a substrate and a water-absorbing cross-linked resin layer provided on a surface of the substrate, the antifogging article being characterized in that the water-absorbing cross-linked resin is a cross-linked resin whose saturated water absorption amount is 45 mg/cm³ or more. The water-absorbing cross-linked resin (antifogging layer) mentioned in Patent Reference 1 expresses antifogging performance by absorbing (absorbing moisture) minute water droplets which adhere to the substrate surface.

### SUMMARY OF INVENTION

The cross-linked resin layer (antifogging layer) mentioned in Patent Reference 1 expands at a time of absorbing moisture and shrinks at a time of releasing moisture. A repetition of the absorption and release of moisture generates stress in the layer of the cross-linked resin and decreases adhesiveness between the cross-linked resin and the substrate, and peel or the like of the cross-linked resin sometimes occurs. Further, in Patent Reference 1, in order to improve the adhesiveness between the substrate and the cross-linked resin, providing a thin film on the substrate surface is proposed. However, providing the thin film between the substrate surface and the antifogging layer in addition to providing the antifogging layer on the substrate surface makes a manufacturing process of the antifogging article complicated and thereby improvement is required.

A subject of the present invention is to solve the above-described conventional problems and provide an antifogging agent composition excellent in an antifogging property and peel resistance and an antifogging article obtained using it, and a manufacturing method thereof.

The present invention is constituted as follows.

The present invention relates to an antifogging agent composition including: a first resin having a water-soluble rate of 90% or more; a second resin having a water-soluble rate of 50% or less; an alkoxysilane compound; and a curing agent, wherein the first resin having the water-soluble rate of 90% or more is a polyfunctional aliphatic epoxy resin, and the second resin having the water-soluble rate of 50% or less is a polyfunctional aromatic epoxy resin having a water-soluble rate of less than 20%.
The present invention relates to an antifogging article including: a substrate; and a cured product of the antifogging agent composition, disposed in at least a part of a region on the substrate.
The present invention relates to a manufacturing method of an antifogging article, the method including: forming an antifogging agent composition layer by applying the antifogging agent composition on a substrate; and forming an antifogging layer by heat-treating the applied antifogging agent composition.

According to the present invention, it is possible to provide an antifogging agent composition excellent in an antifogging property and peel resistance and an antifogging article obtained using it, and a manufacturing method thereof.

### DETAILED DESCRIPTION

A numerical range indicated using “to” in this description indicates a range including the respective numerical values mentioned before and after “to” as a minimum value and a maximum value. Further, when a plurality of substances corresponding to each of components exist in a composition, a content of each of the components in the composition means a total amount of the plurality of substances existing in the composition as long as there is not particular indication.

[Antifogging Agent Composition]

An antifogging agent composition includes: a first resin (hereinafter, also referred to as “highly water-soluble resin”) having a water-soluble rate of 90% or more; a second resin (hereinafter, also referred to as “lowly water-soluble resin”) having a water-soluble rate of 50% or less; an alkoxysilane compound; and a curing agent. A cured product layer (hereinafter, also referred to as “antifogging layer”) of the antifogging agent composition which is formed from the antifogging agent composition of the present invention is excellent in peel resistance (cold-wet-hot cycle resistance). In this description, the highly water-soluble resin and the lowly water-soluble resin are sometimes collectively referred to as “resin component”. Because a cured product to be obtained from the antifogging agent composition of the present invention has good antifogging performance and is excellent in durability, it is useful for obtaining the antifogging article.

(Highly Water-Soluble Resin)

The antifogging agent composition contains the highly water-soluble resin. The highly water-soluble resin is a component having sufficient water absorbing ability so that the cured product to be obtained expresses an antifogging property.

The water-soluble rate of the highly water-soluble resin is 90% or more, preferably 93% or more, and more preferably 95% or more. Further, an upper limit of the water-soluble rate of the highly water-soluble resin is not particularly limited and can be 100%. When the resin has the water-soluble rate of less than 90%, the cured product cannot express the sufficient antifogging property. When the highly water-soluble resin has the water-soluble rate of 93% or more, there is a tendency to improve the antifogging property of the cured product more.

The water-soluble rate refers to a dissolution rate when 10 parts by mass of the resin is mixed relative to 90 parts by mass of water (ion-exchange water) at a room temperature (25° C.). In this description, it is sometimes mentioned as “insoluble” that the water-soluble rate is less than 20%.

As long as the highly water-soluble resin has a functional group (hereinafter, also referred to as “curable group”) which is each independently capable of a curing reaction or which is capable of the curing reaction with the lowly water-soluble resin, under existence of the later described curing agent, the highly water-soluble resin is not particularly limited. The highly water-soluble resin may be a monomer, and may be an oligomer or a polymer in which at least a part of the resin component has reacted. The curable group is not particularly limited, and there can be cited a vinyl group, an epoxy group, a styryl group, an acryloyloxy group, a methacryloyloxy group, an amino group, an ureido group, a chloro group, a thiol group, a sulfide group, a hydroxy group, a carboxy group, an acid anhydride group, and the like. The curable group is preferably the carboxy group, the epoxy group, and the hydroxy group and more preferably the epoxy group. The number of the curable groups can be appropriately selected according to a purpose or the like. The highly water-soluble resin may be independently one kind or a combination of two or more kinds.

When the highly water-soluble resin is the monomer or the oligomer having the functional group capable of the curing reaction, the number of the curable groups contained in one molecule is preferably two or more and more preferably two to ten. Further, the combination of one or more kinds of the highly water-soluble resins having one curable group and the highly water-soluble resin having two or more curable groups may be used. In this case, it is preferable that the average number of the curable groups per one molecule is set to 1.5 or more regarding the combination of the highly water-soluble resins.

The highly water-soluble resin is preferably an epoxy resin having the epoxy group as the curable group. The epoxy resin is not particularly limited as long as it is a resin having one or more epoxy groups in one molecule, and there can be cited an aliphatic epoxy resin, an alicyclic epoxy resin, an aromatic epoxy resin, and so on. The aliphatic epoxy resin is an epoxy resin in which at least one of the epoxy group and a glycidoxy group bonds to an aliphatic group (alkyl group, alkyleneoxy group, alkylene group, and the like). The aromatic epoxy resin is an epoxy resin in which at least one of the epoxy group and the glycidoxy group bonds to an aromatic group (phenyl group, phenylene group, and the like). The alicyclic epoxy resin is an epoxy resin which has an alicyclic group (cyclohexyl group and the like) in a molecule and has at least one epoxy group to be formed by carbon-carbon bonding which forms an alicycle. The epoxy resin is preferably the aliphatic epoxy resin. As long as the epoxy resin is the aliphatic epoxy resin, the water-soluble rate is high and the cured product to be obtained tends to have a higher water absorbing property. Accordingly, when the antifogging agent composition contains the aliphatic epoxy resin as the highly water-soluble resin, the cured product to be obtained is more excellent in the antifogging property. An epoxy resin whose water-soluble rate is 90% or more is preferably an aliphatic epoxy resin having at least one of an ethyleneoxy chain (—CH₂CH₂O—), a propyleneoxy chain (—CH(CH₃)CH₂O—), and the hydroxy group.

The aliphatic epoxy resin is preferably a polyfunctional aliphatic epoxy resin. As long as the epoxy resin is the polyfunctional aliphatic epoxy resin, reactivity of the resin component improves more at a time of forming an antifogging layer and thereby the antifogging layer more excellent in the peel resistance can be obtained. Polyfunctional is two or more functional groups, preferably two to eight functional groups, preferably three to eight functional groups, and particularly preferably 3.5 to five functional groups. The polyfunctional aliphatic epoxy resin is preferably a glycidyl ether compound of alcohol having two or more functional groups and more preferably a glycidyl ether compound of alcohol having three or more functional groups. Alcohol having two or more functional groups is preferably aliphatic alcohol, alicyclic alcohol, or sugar alcohol. Further, the epoxy resin may be a glycidyl ether compound of an oligomer or a polymer which is a reaction product of two or more alcohol molecules each having two or more functional groups. The reaction product of two or more alcohol molecules each having two or more functional groups can have a polyalkylene oxide structure in a molecule.

As the epoxy resin whose water-soluble rate is 90% or more, there can be cited: monofunctional epoxy resins such as phenoxy (ethyleneoxy)₅glycidyl ether and lauryloxy (ethyleneoxy)₁₅glycidyl ether; bifunctional epoxy resins such as ethylene glycol diglycidyl ether, diethylene glycol diglycidyl ether, polyethylene glycol diglycidyl ether, and polypropylene glycol diglycidyl ether; and epoxy resins having three or more functional groups such as glycerol polyglycidyl ether, polyglycerol polyglycidyl ether, and sorbitol polyglycidyl ether. Note that in the above, the numbers behind (ethyleneoxy) indicate the number of repetitions of an ethyleneoxy group. Further, in polypropylene glycol diglycidyl ether, in some whose water-soluble rate is 90% or more, the number of units of a propylene oxide structure is more than two to five or less per one molecule.

An epoxy equivalent of the epoxy resin whose water-soluble rate is 90% or more is not particularly limited, and the epoxy equivalent is preferably 100 to 1,000 and more preferably 130 to 200. Note that in sorbitol polyglycidyl ether, in some whose water-soluble rate is 90% or more, the epoxy equivalent is 170 to 180. The epoxy equivalent can be found by dividing weight-average molecular weight of the epoxy resin by the average number of epoxy groups per one molecule.

When the epoxy resin whose water-soluble rate is 90% or more is the oligomer or the polymer, its molecular weight is not particularly limited and is preferably 500 to 50,000 and particularly preferably 800 to 20,000 in weight-average molecular weight. The weight-average molecular weight is molecular weight in terms of polystyrene by gel permeation chromatography (GPC).

As commercial products of the epoxy resin whose water-soluble rate is 90% or more, for example, there can be cited aliphatic polyepoxide (Denacol EX-1610 (100%) manufactured by Nagase ChemteX Corporation, and the like), glycerol polyglycidyl ether (Denacol EX-313 (99%) manufactured by Nagase ChemteX Corporation, and the like), polyglycerol polyglycidyl ether (Denacol EX-512 (100%) and EX-521 (100%) manufactured by Nagase ChemteX Corporation, and the like), sorbitol polyglycidyl ether (Denacol EX-614B (94%) manufactured by Nagase ChemteX Corporation, and the like), ethylene glycol diglycidyl ether (Denacol EX-810 (100%) and EX-811 (98%) manufactured by Nagase ChemteX Corporation, and the like), diethylene glycol diglycidyl ether (Denacol EX-850 (100%) and EX-851 (99%) manufactured by Nagase ChemteX Corporation, and the like), polyethylene glycol diglycidyl ether (Denacol EX-821 (about 4 moles of an ethylene oxide unit, 100%), EX-830 (about 9 moles of an ethylene oxide unit, 100%), EX-832 (about 9 moles of an ethylene oxide unit, 100%), EX-841 (about 13 moles of an ethylene oxide unit, 100%) and EX-861 (about 22 moles of an ethylene oxide unit, 100%) manufactured by Nagase ChemteX Corporation, and the like), polypropylene glycol diglycidyl ether (Denacol EX-920 (about 3 moles of a propylene oxide unit, 100%) manufactured by Nagase ChemteX Corporation, and the like), phenoxy (ethylene oxide)₅glycidyl ether (Denacol EX-145 (100%) manufactured by Nagase ChemteX Corporation, and the like), and lauryloxy (ethylene oxide)₁₅glycidyl ether (Denacol EX-171 (100%) manufactured by Nagase ChemteX Corporation, and the like). Trade names are in parentheses after the compound names, and the numerical values in parentheses after the trade names are water-soluble rates in the above. Hereinafter, the commercial products of the epoxy resin are similarly mentioned. The water-soluble rate is mentioned as “insoluble” in a case of insoluble.

(Lowly Water-Soluble Resin)

The antifogging agent composition contains the lowly water-soluble resin. By the antifogging agent composition containing the lowly water-soluble resin, an expansion ratio of the antifogging layer can be decreased, expansion of the antifogging layer at a time of absorbing moisture is suppressed, and thereby the antifogging layer excellent in the peel resistance can be obtained.

The water-soluble rate of the lowly water-soluble resin is 50% or less, preferably 40% or less, and more preferably less than 20%. Further, a lower limit of the water-soluble rate of the lowly water-soluble resin is not particularly limited and can be 0%. When the lowly water-soluble resin has the water-soluble rate of more than 50%, the expansion of the antifogging layer due to absorbing moisture is not suppressed and the sufficient peel resistance cannot be exhibited.

The kind of the lowly water-soluble resin is not particularly limited as long as the lowly water-soluble resin has one or more curable groups similarly to the highly water-soluble resin, and any of a monomer, an oligomer, or a polymer is available. The curable group is as described above in the highly water-soluble resin, including preferable ones. The number of the curable groups can be appropriately selected according to a purpose and the like. The lowly water-soluble resin may be independently one kind or a combination of two or more kinds.

When the lowly water-soluble resin is the monomer or the oligomer having a functional group capable of the curing reaction similarly to the highly water-soluble resin, the number of the curable groups contained in one molecule is preferably two or more and more preferably two to ten. Further, the combination of one or more kinds of the lowly water-soluble resins having one curable group and the lowly water-soluble resin having two or more curable groups may be used. In this case, it is preferable that the average number of the curable groups per one molecule is set to 1.5 or more regarding the combination of the lowly water-soluble resins.

The lowly water-soluble resin is preferably an epoxy resin and more preferably an epoxy resin having the water-soluble rate of less than 20%. As the lowly water-soluble resin, the aliphatic epoxy resin or the aromatic epoxy resin is preferable, the aromatic epoxy resin is more preferable, and a polyfunctional aromatic epoxy resin is particularly preferable. As long as the epoxy resin is the aromatic epoxy resin, the water-soluble rate is low and the epoxy resin becomes a resin having a low expansion ratio owing to existence of an aromatic ring compared with the aliphatic epoxy resin. Accordingly, when the antifogging agent composition contains the aromatic epoxy resin as the lowly water-soluble resin, the antifogging layer is more excellent in the peel resistance. Further, as long as the epoxy resin is the polyfunctional aromatic epoxy resin, reactivity improves more and therefore the antifogging layer whose peel resistance is more excellent can be obtained. Further, the lowly water-soluble resin is preferably an epoxy resin which does not have the hydroxy group or an ethylene oxide structure and preferably an epoxy resin which does not have both the hydroxy group and the ethylene oxide structure.

An epoxy equivalent of an epoxy resin having the water-soluble rate of 50% or less is not particularly limited and is preferably 100 to 1000 and more preferably 150 to 300. Note that in sorbitol polyglycidyl ether, in some having the water-soluble rate of 50% or less, the epoxy equivalent is not 170 to 180.

As commercial products of an aromatic epoxy resin having the water-soluble rate of 50% or less, specifically, as monofunctional aromatic epoxy resins, phenyl glycidyl ether (Denacol EX-141 (insoluble) manufactured by Nagase ChemteX Corporation, and the like) and p-t-butylphenyl glycidyl ether (Denacol EX-145 (insoluble) manufactured by Nagase ChemteX Corporation, and the like) can be cited, and as polyfunctional aromatic epoxy resins, resorcinol diglycidyl ether (Denacol EX-201 (insoluble) manufactured by Nagase ChemteX Corporation, and the like) and bisphenol A diglycidyl ether (EP4100 (insoluble) manufactured by ADEKA CORPORATION, and the like) can be cited.

As aliphatic epoxy resins having the water-soluble rate of 50% or less, for example, there can be cited allyl glycidyl ether (Denacol EX-111 (insoluble) manufactured by Nagase ChemteX Corporation, and the like), 2-ethylhexyl glycidyl ether (Denacol EX-121 (insoluble) manufactured by Nagase ChemteX Corporation, and the like), sorbitol polyglycidyl ether (Denacol EX-622 (insoluble) and EX-612 (42%) manufactured by Nagase ChemteX Corporation, and the like), polypropylene glycol diglycidyl ether (Denacol EX-931 (about 11 moles of a propylene oxide unit, insoluble) manufactured by Nagase ChemteX Corporation, and the like), neopentyl glycol diglycidyl ether (Denacol EX-211 (insoluble) manufactured by Nagase ChemteX Corporation, and the like), 1,6-hexanediol diglycidyl ether (Denacol EX-212 (insoluble) manufactured by Nagase ChemteX Corporation, and the like), hydrogenated bisphenol A diglycidyl ether (Denacol EX-252 (insoluble) manufactured by Nagase ChemteX Corporation, and the like), trimethylolpropane polyglycidyl ether (Denacol EX-321 (27%) manufactured by Nagase ChemteX Corporation, and the like), and pentaerythritol polyglycidyl ether (Denacol EX-411 (insoluble) manufactured by Nagase ChemteX Corporation, and the like).

In contents of the first resin having the water-soluble rate of 90% or more and the second resin having the water-soluble rate of 50% or less in the antifogging agent composition, which are not particularly limited, relative to total 100 parts by mass of the first resin having the water-soluble rate of 90% or more and the second resin having the water-soluble rate of 50% or less, it is preferable that the first resin having the water-soluble rate of 90% or more is 10 to 90 parts by mass and the second resin having the water-soluble rate of 50% or less is 90 to 10 parts by mass, it is more preferable that the first resin having the water-soluble rate of 90% or more is 30 to 90 parts by mass and the second resin having the water-soluble rate of 50% or less is 70 to 10 parts by mass, and it is particularly preferable that the first resin having the water-soluble rate of 90% or more is 50 to 80 parts by mass and the second resin having the water-soluble rate of 50% or less is 50 to 20 parts by mass. Relative to total 100 parts by mass of the first resin having the water-soluble rate of 90% or more and the second resin having the water-soluble rate of 50% or less, as long as the first resin having the water-soluble rate of 90% or more is 10 parts by mass or more, the antifogging property of the antifogging layer improves more, and as long as it is 90 parts by mass or less, the peel resistance improves more.

A content of the resin component in the antifogging agent composition is preferably 95 to 50 mass % in the composition and more preferably 90 to 60 mass % therein. Note that the content of the resin component is a content in terms of solid content. In present invention, the content in terms of solid content of a component refers to mass of a residue except a volatile component such as water.

(Curing Agent)

The curing agent is not particularly limited as long as it is the one which cures the highly water-soluble resin and the lowly water-soluble resin, and it can be appropriately selected according to the kind or the like of the resins. As the above curing agent, there can be cited a compound (hereinafter, also referred to as “curing agent (A)”) which has two or more functional groups (hereinafter, also referred to as “reactive group”) capable of reacting with the curable group of the resins and reacts with the resin component and a compound (hereinafter, also referred to as “curing agent (B)”) which accelerates the curing reaction by catalyzing the curing reaction of the resin component.

<Curing Agent (A)>

The reactive group of the curing agent (A) can be appropriately selected according to the kind or the like of the curable group of the resin component. As the reactive group, there can be cited a vinyl group, an epoxy group, a styryl group, an acryloyloxy group, a methacryloyloxy group, an amino group, an ureido group, a chloropropyl group, a mercapto group, a sulfide group, an isocyanato group, a hydroxy group, a carboxy group, an acid anhydride group, and the like. For example, when the curable group is the carboxy group, the reactive group is preferably the epoxy group, the amino group, and so on and particularly preferably the epoxy group and the like. When the curable group is the hydroxy group, the reactive group is preferably the epoxy group, the isocyanato group, and so on. When the curable group is the epoxy group, the reactive group is preferably the carboxy group, the amino group, the acid anhydride group, the hydroxy group, and so on.

The number of reactive groups which one molecule of the curing agent (A) has is preferably 1.5 or more on average and more preferably two to eight. When the number of reactive groups is 1.5 or more, the antifogging layer excellent in a balance between the antifogging property and abrasion resistance can be obtained.

As the curing agent (A), which is not particularly limited, there can be cited a polyamine-based compound, a polycarboxylic acid-based compound (including polycarboxylic acid anhydride), a polyol-based compound, a polyisocyanate-based compound, a polyepoxy-based compound, dicyandiamides, organic acid dihydrazides, and the like. When the resin component is the epoxy resin, the polyamine-based compound, the polyol-based compound, the polycarboxylic acid anhydride, and so on can be cited as the curing agent (A) and the polyol-based compound and the polycarboxylic acid anhydride are preferable. When the resin component is a resin having the carboxy group, the curing agent (A) is preferably the polyepoxy-based compound and the polyisocyanate-based compound.

As the polyamine-based compound, an aliphatic polyamine compound and an alicyclic polyamine compound are preferable. Specifically, ethylenediamine, triethylenetetramine, tetraethylenepentamine, hexamethylenediamine, isophoronediamine, menthenediamine, meta-phenylenediamine, polyoxypropylene polyamine, polyoxy glycol polyamine, 3,9-bis(3-aminopropyl)-2,4,8,10-tetraoxaspiro(5,5)undecane, and the like are preferable.

As the polycarboxylic acid-based compound, oxalic acid, malonic acid, succinic acid, malic acid, citric acid, methyltetrahydrophthalic acid anhydride, hexahydrophthalic acid anhydride, 4-methylhexahydrophthalic acid anhydride, and the like are preferable.

As the polyol-based compound, there can be cited polyhydric alcohol having three or more hydroxy groups, polyether polyol, polyester polyol, and the like, and polyether polyol is preferable. Polyether polyol is not particularly limited and can be obtained by reacting alkylene oxide (ethylene oxide, propylene oxide, and the like) with polyhydric alcohol having three or more hydroxy groups.

As polyhydric alcohol having three or more hydroxy groups, there can be cited glycerin, trimethylolethane, trimethylolpropane, diglycerin, triglycerin, ditrimethylolpropane, 1,2,6-hexanetriol, pentaerythritol, dipentaerythritol, and the like. Polyhydric alcohol having three or more hydroxy groups may be independently one kind or a combination of two or more kinds.

As the polyol-based compound, as commercial products, for example, there can be cited “SANNIX GP-250”, “SANNIX GP-400”, “SANNIX GP-600”, “SANNIX GP-1000”, and “SANNIX GP-1500” manufactured by Sanyo Chemical Industries, Ltd., “TMP-30”, “TMP-60”, and “TMP-90” manufactured by Nippon Nyukazai Co., Ltd., and the like.

As the polyisocyanate-based compound, hexamethylenediisocyanate, isophorone diisocyanate, and the like are preferable. As the polyepoxy-based compound, the compounds described above as the epoxy resin can be cited. The curing agent (A) may be independently one kind or a combination of two or more kinds.

A content of the curing agent (A) is not particularly limited and is preferably 0.1 to 30 parts by mass and more preferably 0.2 to 28 parts by mass relative to total 100 parts by mass of the highly water-soluble resin and the lowly water-soluble resin. Relative to total 100 parts by mass of the highly water-soluble resin and the lowly water-soluble resin, as long as the content of the curing agent (A) is 0.1 part by mass or more, the curing reaction progresses sufficiently and precipitation of an unreacted substance from the cured product tends to be suppressed, and as long as it is 30 parts by mass or less, there is a tendency to improve the anti fogging property of the cured product more without a deficiency of the resin component. Note that the content of an amine-based curing agent such as the polyamine-based compound, dicyandiamides, or organic acid dihydrazides is preferably 0.5 part by mass or less relative to total 100 parts by mass of the highly water-soluble resin and the lowly water-soluble resin, and it is preferable that the amine-based curing agent is not substantially contained. When the content of the amine-based curing agent is 0.5 part by mass or less relative to total 100 parts by mass of the highly water-soluble resin and the lowly water-soluble resin, the antifogging layer in which yellowing is greatly reduced can be obtained.

<Curing Agent (B)>

The curing agent (B) is the compound which is usually known as a polymerization catalyst, and can be appropriately selected according to the resin component. The curing agent (B) is not particularly limited and there can be cited an aluminum compound, perchlorate, tris(dimethylaminomethyl)phenols, dimethylbenzylamines, phosphines, imidazoles, and the like. When the resin component is the epoxy resin, the curing agent (B) is preferably the aluminum compound and perchlorate.

The aluminum compound is not particularly limited and there can be cited: aluminum alkoxide such as aluminum butoxide, aluminum t-butoxide, aluminum sec-butoxide, aluminum ethoxide, or aluminum isopropoxide; and an aluminum complex such as tris(2,4-pentanedionato)aluminum(III), aluminum hexafluoroacetylacetonate, aluminum trifluoroacetylacetonate, or tris(2,2,6,6-tetramethyl-3,5-heptanedionato)aluminum(III) and the aluminum complex is preferable.

Perchlorate is not particularly limited and there can be cited sodium perchlorate, potassium perchlorate, magnesium perchlorate, ammonium perchlorate, and the like, and ammonium perchlorate is preferable. The curing agent (B) may be independently one kind or a combination of two or more kinds.

A content of the curing agent (B) is not particularly limited and is preferably 0.1 to 30 parts by mass, more preferably 0.1 to 5 parts by mass, and particularly preferably 0.2 to 4 parts by mass relative to total 100 parts by mass of the first resin having the water-soluble rate of 90% or more and the second resin having the water-soluble rate of 50% or less. Relative to total 100 parts by mass of the first resin having the water-soluble rate of 90% or more and the second resin having the water-soluble rate of 50% or less, as long as the content of the curing agent (B) is 0.1 part by mass or more, the curing reaction becomes sufficient and the precipitation of the unreacted substance from the antifogging layer tends to be suppressed, and as long as it is 30 parts by mass or less, the curing agent does not become excessive and the precipitation of an excessive curing agent from the antifogging layer tends to be suppressed.

When the curing agent (A) and the curing agent (B) are used in combination, a mass ratio of the curing agent (A) and the curing agent (B) is not particularly limited and curing agent (B)/curing agent (A)=0.1/100 to 5/100 is preferable and curing agent (B)/curing agent (A)=0.5/100 to 3/100 is more preferable. As long as curing agent (B)/curing agent (A) is 0.1/100 or more, an effect of accelerating a reaction of the curing agent (A) tends to be obtained, and as long as curing agent (B)/curing agent (A) is 5/100 or less, there is a tendency not to inhibit the reaction of the curing agent (A).

The highly water-soluble resin, the lowly water-soluble resin, and the curing agents may be each contained independently or may be contained in forms of a pre-polymer of the highly water-soluble resin, a pre-polymer of the lowly water-soluble resin, and a pre-polymer of a mixture of the highly water-soluble resin and the lowly water-soluble resin which have been pre-polymerized under the existence of the curing agents.

A manufacturing method of the pre-polymer of the highly water-soluble resin is not particularly limited, and the pre-polymer of the highly water-soluble resin can be obtained by mixing the highly water-soluble resin, the curing agents, and depending on circumstances a solvent, and reacting. As the curing agents, at least one of the curing agent (A) and the curing agent (B) can be cited. As the solvent, the later-described solvent can be cited and ester is preferable.

As amounts of the highly water-soluble resin and the curing agents, amounts which satisfy the contents of the components in the above-described antifogging agent composition can be cited. The content of the curing agent (A) is not particularly limited and is preferably 0.05 to 15 parts by mass and more preferably 0.1 to 10 parts by mass relative to 100 parts by mass of the highly water-soluble resin. The content of the curing agent (B) is not particularly limited and is preferably 0.05 to 15 parts by mass and more preferably 0.1 to 10 parts by mass relative to 100 parts by mass of the highly water-soluble resin. When the curing agent (A) and the curing agent (B) are used in combination, a content ratio of the curing agent (A) and the curing agent (B) is as described above, including preferable ones.

An amount of the solvent is not particularly limited, and an amount which is the later-described content of the solvent in the antifogging agent composition can be cited.

A reaction temperature is not particularly limited as long as it is a temperature at which the resin component and the curing agents react with one another or the resin components react with each other and the pre-polymer can be obtained, and it is preferably 80 to 150° C. and more preferably 100 to 130° C. Reaction time can be appropriately set according to the reaction temperature and is preferably 1 to 240 minutes and more preferably 5 to 180 minutes. When the reaction time is one minute or more, a polymerization reaction tends to progress sufficiently, and when it is 240 minutes or less, there is a tendency to make it possible to prevent a viscosity rise of the solution due to excessive progress of the reaction.

The pre-polymer of the lowly water-soluble resin and the pre-polymer of the mixture of the highly water-soluble resin and the lowly water-soluble resin can be obtained in a similar manner to the pre-polymer of the highly water-soluble resin.

(Alkoxysilane Compound)

The alkoxysilane compound is a compound having 1 to 4 alkoxy groups which bond to a silicon atom in one molecule. By the antifogging agent composition containing the alkoxysilane compound, it is possible to enhance the peel resistance between a substrate and the antifogging layer.

As the alkoxysilane compound, a compound represented by the following general formula (I) can be cited.

(R¹O)ₚSiR²₍₄₋ₚ₎ (I)

In the formula, each R¹ independently represents an alkyl group having 1 to 4 carbon atoms, each R² independently represents an alkyl group having 1 to 10 carbon atoms, which may have a substituent, and p represents the number of 1 to 4. When R¹ or R² exists in a plural state, they may be the same or different from each other.

R¹ is the alkyl group having 1 to 4 carbon atoms, there can be cited a methyl group, an ethyl group, a propyl group, an isopropyl group, a butyl group, an isobutyl group, and a t-butyl group, and the methyl group and the ethyl group are preferable. In R², the alkyl group having 1 to 10 carbon atoms is liner or branched, and there can be cited a methyl group, an ethyl group, a propyl group, an isopropyl group, a butyl group, an isobutyl group, a t-butyl group, a hexyl group, a decyl group, and the like. R² is preferably the alkyl group having 1 to 6 carbon atoms. In R², the substituent is not particularly limited, and there can be cited an epoxy group, a glycidoxy group, a methacryloyloxy group, an acryloyloxy group, an isocyanato group, a hydroxy group, an amino group, a phenylamino group, an alkylamino group, an aminoalkylamino group, an ureido group, a mercapto group, an acid anhydride group, and the like. When the first resin having the water-soluble rate of 90% or more and the second resin having the water-soluble rate of 50% or less are the epoxy resin, the isocyanato group, the acid anhydride group, the epoxy group, and the glycidoxy group are preferable as the substituent. Note that in R², “alkyl group having 1 to 10 carbon atoms” means that the number of carbon atoms of the alkyl group except the substituent is 1 to 10.

p is preferably 1 to 3 and more preferably 3. When p is 3 or less, there is a tendency to improve the abrasion resistance of the cured product to be obtained more compared with a compound in which p is 4 (namely, tetraalkoxysilane).

As the alkoxysilane compound, there can be cited: a tetraalkoxysilane compound such as tetramethoxysilane or tetraethoxysilane having four alkoxy groups which bond to a silicon atom in one molecule; and an alkoxysilane compound such as 3-glycidoxypropyltrimethoxysilane, 3-glycidoxypropyltriethoxysilane, 3-glycidoxypropylmethyldiethoxysilane, 3-methacryloxypropylmethyldimethoxysilane, 3-methacryloxypropyltrimethoxysilane, 3-acryloxypropyltrimethoxysilane, 3-isocyanatopropyltrimethoxysilane, N-(2-aminoethyl)-3-aminopropylmethyldimethoxysilane, N-(2-aminoethyl)-3-aminopropyltrimethoxysilane, 3-aminopropyltrimethoxysilane, 3-aminopropylmethyldimethoxysilane, N-phenyl-3-aminopropyltrimethoxysilane, 3-ureidopropyltriethoxysilane, or 3-mercaptopropyltrimethoxysilane having two or three alkoxy groups which bond to a silicon atom in one molecule. The alkoxysilane compound having three alkoxy groups which bond to a silicon atom in one molecule is preferable among these, and 3-glycidoxypropyltrimethoxysilane and 3-glycidoxypropyltriethoxysilane are more preferable.

A content of the alkoxysilane compound is not particularly limited and is preferably 5 to 40 parts by mass and more preferably 8 to 30 parts by mass relative to total 100 parts by mass of the highly water-soluble resin and the lowly water-soluble resin. Relative to total 100 parts by mass of the highly water-soluble resin and the lowly water-soluble resin, as long as the content of the alkoxysilane compound is 5 parts by mass or more, adhesiveness between the antifogging layer and the substrate improves more and the peel resistance tends to improve more, and as long as it is 30 parts by mass or less, coloring of the antifogging layer due to oxidation of the resins tends to be reduced even when the antifogging article is exposed to high temperatures.

The alkoxysilane compound may be a partially hydrolyzed condensate in which at least a part of molecules hydrolyzes and condenses each other. When the antifogging agent composition contains the partially hydrolyzed condensate of the alkoxysilane compound, the adhesiveness between the antifogging layer and the substrate improves more and the peel resistance tends to improve more.

The partially hydrolyzed condensate of the alkoxysilane compound can be obtained by mixing the alkoxysilane compound, water, the later-described solvent, and, depending on circumstances, an acid catalyst. As the acid catalyst, hydrochloric acid, nitric acid, sulfuric acid, and the like can be cited. Amounts of the alkoxysilane compound, water, the solvent, and the acid catalyst are not particularly limited as long as they are under a condition that a desired partially hydrolyzed condensate can be obtained. The amount of water is preferably 4 to 20 moles and more preferably 7 to 16 moles relative to 1 mole of the alkoxysilane compound. The amount of the solvent is preferably 5 to 50 parts by mass and more preferably 10 to 40 parts by mass relative to 100 parts by mass of the alkoxysilane compound. The amount of the acid catalyst is preferably 0.1 to 5.0 parts by mass and more preferably 0.2 to 3.5 parts by mass relative to 100 parts by mass of the alkoxysilane compound.

A mixing temperature is not particularly limited as long as it is a temperature at which the alkoxysilane compound reacts and a hydrolyzed condensate can be obtained, and it is preferably 15 to 80° C. and more preferably 20 to 30° C. Mixing time can be appropriately set according to the mixing temperature and is preferably 1 to 180 minutes and more preferably 5 to 120 minutes. When the mixing time is one minute or more, the adhesiveness between the antifogging layer and the substrate improves more and the peel resistance tends to improve more, and when it is 120 minutes or less, there is a tendency to suppress a viscosity rise of a coating solution. When the antifogging agent composition contains the partially hydrolyzed condensate of the alkoxysilane compound, a content of the hydrolyzed condensate of the alkoxysilane compound is calculated using an amount of a raw material alkoxysilane compound used for obtaining the partially hydrolyzed condensate as an amount of the partially hydrolyzed condensate.

(Solvent)

The antifogging agent composition may contain the solvent. By the antifogging agent composition containing the solvent, there is a tendency to improve coating workability. As long as the solvent has good solubility of components of the resin component, the curing agents, and the like and is a solvent having low reactivity with respect to these components, it is not particularly limited. As the solvent, there can be cited alcohol (methanol, ethanol, 2-propanol, and the like), ester (acetate (butyl acetate) and the like), ether (diethylene glycol dimethyl ether and the like), ketone (methyl ethyl ketone and the like), water (ion-exchange water and the like), and the like, and ester and alcohol are preferable. The solvent may be independently one kind or a combination of two or more kinds. Note that the resin component, the curing agents, and/or the alkoxysilane compound are sometimes used as a mixture of the solvent with each of them independently or a combination of two or more of them. In this case, the solvent contained in the mixture may be used as the solvent in the antifogging agent composition and another solvent may be used as the solvent in the antifogging agent composition by adding it further.

A content of the solvent is not particularly limited and is preferably 0.1 to 500 parts by mass and more preferably 1 to 300 parts by mass relative to total 100 parts by mass of the highly water-soluble resin, the lowly water-soluble resin, the curing agents, and the alkoxysilane compound. Relative to total 100 parts by mass of the highly water-soluble resin, the lowly water-soluble resin, the curing agents, and the alkoxysilane compound, as long as the content of the solvent is 0.1 part by mass or more, there is tendency to allow suppression of rapid progress of the curing reaction of a component, and as long as it is 500 parts by mass or less, the curing reaction of the component tends to moderately progress.

(Further Component)

The antifogging agent composition can contain further components in a range where effect of the present invention is exhibited. As such components, there can be cited a further resin, a filler, a leveling agent, a surfactant, a UV absorbent, a light stabilizer, an antioxidant, and the like.

<Further Resin>

As the further resin, which is not particularly limited, a resin having a water-absorbing rate of more than 50% to less than 90% can be cited. The resin having the water-absorbing rate of more than 50% to less than 90% is not particularly limited, and a resin having a curable group and having this water-absorbing rate can be cited. As the curable group of the resin having the curable group, the ones described above in the highly water-soluble resin can be cited. As cured products of the further resin, there can be cited: a starch-based resin such as a composite of a starch-acrylonitrile graft polymer hydrolysate, a starch-acrylic acid graft polymer and the like; a cellulose-based resin such as a cellulose-acrylonitrile graft polymer or a cross-linked body of carboxymethyl cellulose; a polyvinyl alcohol-based resin such as a polyvinyl alcohol cross-linked polymer; an acrylic resin such as a sodium polyacrylate cross-linked body or a polyacrylic ester cross-linked body; a polyether-based resin such as a polyethylene glycol diacrylate cross-linked polymer or a polyalkylene oxide-polycarboxylic acid cross-linked body; cross-linked polyurethane which is a reaction product of polyisocyanate with polyether polyol and/or polyester polyol; and the like. A content of the further resin is preferably 20 parts by mass or less and more preferably 5 parts by mass or less relative to total 100 parts by mass of the highly water-soluble resin and the lowly water-soluble resin, and it is particularly preferable that the further resin is not substantially contained.

<Filler>

The antifogging agent composition may contain the filler. When the antifogging agent composition contains the filler, it is possible to increase mechanical strength and heat resistance of the antifogging layer and there is a tendency to allow a reduction in curing shrinkage of the resin component. As the filler, an inorganic filler and an organic filler can be cited, and the inorganic filler is preferable. As the inorganic filler, there can be cited silica, alumina, titania, zirconia, ITO (indium tin oxide), or the like, and silica or ITO is preferable. When the filler is silica, the water absorbing property tends to be given to the antifogging layer. Further, because ITO has infrared absorbency, heat ray absorbency is given to the antifogging layer and an antifogging effect owing to heat ray absorption can also be promising.

An average particle diameter of the filler is preferably 0.01 to 0.3 μm and more preferably 0.02 to 0.25 μm. When the resin component is the epoxy resin, a content of the filler is preferably 1 to 20 parts by mass and more preferably 1 to 10 parts by mass relative to total 100 parts by mass of the highly water-soluble resin, the lowly water-soluble resin, and the curing agents. Relative to total 100 parts by mass of the highly water-soluble resin, the lowly water-soluble resin, and the curing agents, when the content of the filler is 1 part by mass or more, there is a tendency to improve a reduction effect of the curing shrinkage of the resin, and when it is 20 parts by mass or less, space for absorbing moisture in the antifogging layer can be secured sufficiently and there is a tendency to improve the antifogging property. The average particle diameter is a volume-based median diameter when it is measured using a laser diffraction/scattering particle diameter distribution apparatus.

<Leveling Agent>

The antifogging agent composition may contain the leveling agent. When the antifogging agent composition contains the leveling agent, a thickness of the antifogging agent composition layer tends to become even, so that there is a tendency to suppress perspective distortion of the antifogging article. As the leveling agent, a silicone-based leveling agent, a fluorine-based leveling agent, and so on can be cited, and the silicone-based leveling agent is preferable. As the silicone-based leveling agent, there can be cited amino-modified silicone, carbonyl-modified silicone, epoxy-modified silicone, polyether-modified silicone, alkoxy-modified silicone, and so on. An addition amount of the leveling agent is preferably 0.02 to 1 part by mass, more preferably 0.02 to 0.3 part by mass, and particularly preferably 0.02 to 0.1 part by mass relative to total 100 parts by mass of the highly water-soluble resin, the lowly water-soluble resin, the alkoxysilane compound, and the curing agents. Relative to total 100 parts by mass of the highly water-soluble resin, the lowly water-soluble resin, the alkoxysilane compound, and the curing agents, when a content of the leveling agent is 0.02 part by mass or more, the thickness of the antifogging agent composition layer tends to become more even, and when it is 1 part by mass or less, there is a tendency to suppress occurrence of cloudiness of the antifogging layer.

<Surfactant>

The antifogging agent composition may contain the surfactant. When the antifogging agent composition contains the surfactant, the thickness of the antifogging agent composition layer tends to become even, so that there is a tendency to suppress the perspective distortion of the antifogging article. As the surfactant, which is not particularly limited, there can be cited a nonionic surfactant, a cationic surfactant, a betaine-based surfactant, and an anionic surfactant. When the surfactant is a surfactant having an alkyleneoxy chain such as an ethyleneoxy chain or a propyleneoxy chain, a hydrophilic property can be given to the antifogging agent composition and there is a tendency to improve the antifogging property of the antifogging layer more, which is therefore preferable. An addition amount of the surfactant is preferably 0.02 to 1 part by mass, more preferably 0.02 to 0.3 part by mass, and particularly preferably 0.02 to 0.1 part by mass relative to total 100 parts by mass of the highly water-soluble resin, the lowly water-soluble resin, the alkoxysilane compound, and the curing agents. Relative to total 100 parts by mass of the highly water-soluble resin, the lowly water-soluble resin, the alkoxysilane compound, and the curing agents, when a content of the surfactant is 0.02 part by mass or more, the thickness of the antifogging agent composition layer tends to become more even, and when it is 1 part by mass or less, there is tendency to suppress the occurrence of the cloudiness of the antifogging layer.

[Antifogging Article]

In the present invention, an antifogging article includes: a substrate; and a cured product of the antifogging agent composition, disposed in at least a part of a region on the substrate. Note that it is preferable that the antifogging article does not have a primer layer for adhesion improvement between the substrate and the cured product of the antifogging agent composition. The antifogging article is excellent in the antifogging property and the peel resistance.

(Substrate)

As the substrate, which is not particularly limited, there can be cited glass, plastic, metal, ceramics, and combinations of these (for example, composite material, layered material, and the like). Among them, a light-transmissive substrate selected from a group consisting of glass, plastic, and combinations of these is preferable. A shape of the substrate is not particularly limited, and there can be cited a flat shape, a shape in which the whole surface or a part thereof has a curvature, and the like. A thickness of the substrate is not particularly limited and can be appropriately selected depending on application of the antifogging article. The thickness of the substrate is preferably 1 to 10 mm.

(Cured Product of Antifogging Agent Composition)

The cured product of the antifogging agent composition is disposed in at least a part of the region on the substrate and preferably disposed over the whole surface of at least one surface of the substrate. The antifogging agent composition is as described above, also including preferable ones. A thickness of the antifogging layer which is the cured product of the antifogging agent composition is preferably 5 to 50 μm and particularly preferably 10 to 30 μm. When the thickness of the antifogging layer is 5 μm or more, there is a tendency to express a required antifogging property sufficiently, and when it is 50 μm or less, there is a tendency to sufficiently exhibit the peel resistance between the substrate and the antifogging layer.

[Manufacturing Method of Antifogging Article]

In the present invention, an antifogging article can be obtained by a manufacturing method including: forming an antifogging agent composition layer by applying the antifogging agent composition on a substrate; and forming an antifogging layer by heat-treating the applied antifogging agent composition.

The antifogging layer which is a cured product of the antifogging agent composition is formed by a reaction and curing of a highly water-soluble resin, a lowly water-soluble resin, and curing agents contained in the antifogging agent composition or by a reaction and curing of the highly water-soluble resin and the lowly water-soluble resin under existence of the curing agents, as a result of heat treatment.

An applying method of the antifogging agent composition is not particularly limited, and there can be cited a spin coating, a dip coating, a spray coating, a flow coating, a die coating, and the like, and the flow coating and the spin coating are preferable. A thickness of the antifogging agent composition layer is not particularly limited as long as it is a thickness which becomes a thickness allowing a desired antifogging layer to be obtained.

An applied amount of the antifogging agent composition which is applied on a surface of the substrate is not particularly limited as long as it is an amount which becomes the thickness of the above-described antifogging agent composition layer, and the applied amount is preferably 1.6 to 1,600 g/m² and more preferably 8.0 to 800 g/m² as a solid content. The heat treatment of the antifogging agent composition layer can be performed by an arbitrary heating device such as an electric furnace, a gas furnace, or an infrared heating furnace which is set to a predetermined temperature. A heat treatment temperature is not particularly limited and is preferably 80 to 220° C. and more preferably 80 to 200° C. When the heat treatment temperature is 80° C. or more, a decrease in adhesion strength due to a reaction deficiency of a resin component and the like tends not to occur, and when it is 220° C. or less, there is a tendency to suppress formation of discoloration of the antifogging layer. Heat treatment time can be appropriately set according to a heating heat treatment temperature and is preferably 1 to 180 minutes and more preferably 5 to 120 minutes. When the heat treatment time is one minute or more, the decrease in the adhesion strength due to the reaction deficiency of the resin component and the like tends not to occur, and when it is 180 minutes or less, there is a tendency to suppress the discoloration of the antifogging layer.

[Application of Antifogging Article]

As application of the antifogging article, there can be cited a window glass for transportation equipment (automobile, railway vehicle, boat, aircraft, or the like), a refrigerated display case, a dressing table mirror, a bathroom mirror, an optical apparatus, or the like.

### EXAMPLE

Hereinafter, the present invention will be further described by citing examples, but the present invention is not limited to these examples. Note that Examples 8 to 11, 13 to 16, 18 to 21, 23 to 25, 27 to 30 which are described below are examples, and Examples 1 to 7, 12, 17, 22, 26, 31 which are described below are comparative examples.

Abbreviations and physical properties of compounds used in the examples and the comparative examples are summarized below.

### (1) Epoxy Resin (Denacol is a Trade Name by Nagase ChemteX Corporation.)

### (1-1) Highly Water-Soluble Resin

EX1610: Denacol EX-1610 (polyfunctional aliphatic epoxy resin, water-soluble rate 100%)

EX614B: Denacol EX-614B (polyfunctional aliphatic epoxy resin, water-soluble rate 94%)

### (1-2) Lowly Water-Soluble Resin

EP4100: ADEKA RESIN EP4100 (trade name, manufactured by ADEKA CORPORATION, bisphenol A diglycidyl ether, water-soluble rate: insoluble)

EX622: Denacol EX-622 (polyfunctional aliphatic epoxy resin, water-soluble rate: insoluble)

EX612: Denacol EX-612 (polyfunctional aliphatic epoxy resin, water-soluble rate 42%)

### (2) Curing Agent

NH₄ClO₄: ammonium perchlorate (manufactured by Wako Pure Chemical Industries, Ltd.)

Al(acac)₃: tris(2,4-pentanedionato)aluminum(III) (manufactured by KANTO CHEMICAL CO., INC.)

TMP-30: trimethylolpropane tripolyoxyethylene ether (manufactured by Nippon Nyukazai Co., Ltd.)

### (3) Alkoxysilane Compound

GPTMS: 3-glycidoxypropyltrimethoxysilane (manufactured by JNC CORPORATION: Sila-Ace 501)

TEOS: tetraethoxysilane (manufactured by Tokyo Chemical Industries)

### (4) Solvent

SOLMIX AP-1: (manufactured by JAPAN ALCOHOL TRADING COMPANY LIMITED, mixed solvent of ethanol:2-propanol:methanol=85.5:13.4:1.1 (mass ratio))

Evaluation of an antifogging article in each example was performed as follows.

### [Measurement of Film Thickness (Thickness of Antifogging Layer)]

A cross-sectional image of the antifogging article was taken with a scanning electron microscope (manufactured by Hitachi, Ltd., S4300), and a thickness of an antifogging layer was measured.

[Evaluation of Water-Absorbing Antifogging Property]

A surface of the antifogging layer of the antifogging article left under an environment of 20° C. and a relative humidity of 50% for 1 hour was held up (distance of 8.5 cm) above a hot water bath of 35° C., and antifogging time (second) until fogging is perceived was measured. The fogging occurred in 1 to 2 seconds on a normal soda lime glass which is not subjected to an antifogging process. Antifogging performance to be required is different depending on application. In the examples, practically, a water-absorbing antifogging property of 40 seconds or more is necessary, and the one of 80 seconds or more is preferable and the one of 100 seconds or more is more preferable.

[Measurement of Haze]

A haze (%) of the antifogging article was measured using a haze meter (haze-gard plus, manufactured by Gardner Laboratory, Inc.) in conformity to a standard of JIS K7361.

[Evaluation of Abrasion Resistance]

Evaluation was performed in conformity to JIS R3212 (vehicle-interior side). In a 5130 type abrasion tester of Taber Industries, a wear ring CS-10F was used. The haze (%) was measured in a similar manner to the above-described one after performing an abrasion test in which the wear ring was brought in contact with the surface of the antifogging layer of the antifogging article, and rotated 100 times while applying a load of 4.90 N thereto. Abrasion resistance was evaluated by subtracting a haze before the abrasion test from the haze after the abrasion test and finding a haze change AH (%).

[Cold-Wet-Hot Cycle Test (Peel Resistance Test)]

A surface side of the antifogging layer of the antifogging article of 100 mm×50 mm is covered with a cover of 100 mm×50 mm×10 mm, distilled water of 500 μL is added therein, a gap between the antifogging article and the cover is sealed with an aluminum tape to be closed tightly, and the antifogging article is kept at −30° C. for 1 hour, kept at 25° C. for 1 hour after the temperature rises to 25° C. while spending 30 minutes, and cooled to −30° C. while spending 30 minutes. This cycle was operated continuously, and the number of cycles in which peel of the antifogging layer was observed by visual observation was measured.

[Evaluation of Adhesiveness]

Evaluation was performed in conformity of a standard of JIS K5400-8.5. A tessellated cut whose one side is 1 mm was formed on the surface of the antifogging layer of the antifogging article, and a peel test was performed with Sellotape (registered trademark) (trade name) manufactured by Nichiban Co., Ltd. Presence/absence of peel of 100 squares was counted, and the ones having no peel was regarded as 100/100 and a case where all the squares stuck to Sellotape (registered trademark) and peeled was regarded as 0/100.

<1> Preparation of Antifogging Agent Composition

### [Sol-Gel Hydrolysis Composition A1]

In a glass container in which a stirrer and a thermometer were set, 36.7 g of SOLMIX AP-1, 39.3 g of GPTMS, and 24.0 g of 0.1 mol/L nitric acid (manufactured by JUNSEI CHEMICAL CO., LTD.) were put and stirred at 25° C. for 1 hour to obtain a sol-gel hydrolysis composition (A1) containing a partially hydrolyzed condensate of GPTMS.

[Sol-Gel Hydrolysis Composition A2]

In a glass container in which a stirrer and a thermometer were set, 41.4 g of SOLMIX AP-1, 34.7 g of TEOS, and 24.0 g of 0.1 mol/L nitric acid (manufactured by JUNSEI CHEMICAL CO., LTD.) were put and stirred at 25° C. for 1 hour to obtain a sol-gel hydrolysis composition (A2) containing a partially hydrolyzed condensate of TEOS.

[Highly Water-Soluble Resin Pre-Polymer B1]

EX1610: 30.1 g, TMP-30: 7.9 g, ammonium perchlorate: 0.13 g, and butyl acetate 22.1 g were fed, the temperature was increased to 60° C. while they were being stirred, and they were dissolved, heated to 120° C., and reacted for 2 hours, and thereby a highly water-absorbing resin pre-polymer (B1) was obtained.

[Highly Water-Soluble Resin Pre-Polymer B2]

EX614B: 30.6 g, TMP-30: 7.9 g, ammonium perchlorate: 0.18 g, and butyl acetate 22.6 g were fed, the temperature was increased to 60° C. while they were being stirred, and they were dissolved, heated to 120° C., and reacted for 2 hours, and thereby a highly water-absorbing resin pre-polymer (B2) was obtained.

[Lowly Water-Absorbing Resin Pre-Polymer C1]

EP4100: 33.6 g, TMP-30: 7.9 g, ammonium perchlorate: 0.14 g, and butyl acetate 25.6 g were fed, the temperature was increased to 60° C. while they were being stirred, and they were dissolved, heated to 120° C., and reacted for 2 hours, and thereby a lowly water-absorbing resin pre-polymer (C1) was obtained.

[Lowly Water-Absorbing Resin Pre-Polymer C2]

EX622: 33.8 g, TMP-30: 7.9 g, ammonium perchlorate: 0.14 g, and butyl acetate 25.8 g were fed, the temperature was increased to 60° C. while they were being stirred, and they were dissolved, heated to 120° C., and reacted for 2 hours, and thereby a lowly water-absorbing resin pre-polymer (C2) was obtained.

[Lowly Water-Absorbing Resin Pre-Polymer C3]

EX612: 29.4 g, TMP-30: 7.9 g, ammonium perchlorate: 0.12 g, and butyl acetate 21.4 g were fed, the temperature was increased to 60° C. while they were being stirred, and they were dissolved, heated to 120° C., and reacted for 2 hours, and thereby a lowly water-absorbing resin pre-polymer (C3) was obtained.

[Curing Agent Dilution D]

In a glass container in which a stirrer and a thermometer were set, 3.0 g of Al(acac)₃ and 97.0 g of methanol (JUNSEI CHEMICAL; the highest quality) were put and stirred at 25° C. for 10 minutes to obtain a curing agent dilution (D).

<2> Manufacture and Evaluation of Antifogging Article

An antifogging layer was formed on each substrate as follows using each kind of the compositions obtained in the above-described manufacturing examples, and evaluation was performed by the above-described evaluation methods.

### Example 1

In a glass container in which a stirrer and a thermometer were set, 70.0 g of the highly water-absorbing resin pre-polymer (B1) and 30.0 g of SOLMIX AP-1 were put and stirred at 25° C. for 10 minutes to obtain a coating solution 1 as an antifogging agent composition. After that, a dried clean soda lime glass substrate (water contact angle 3°, 100 mm×100 mm×3.5 mm thickness) whose surface was polished and cleaned with cerium oxide was used as a substrate, and an antifogging article having an antifogging layer was obtained by applying the coating solution 1 to a surface of the glass substrate with a spin coat (manufactured by MIKASA CO. LDT., 50 rpm, 30 seconds) and holding the glass substrate at 100° C. in an electric furnace for 30 minutes.

### Example 2

In a glass container in which a stirrer and a thermometer were set, 66.5 g of the highly water-absorbing resin pre-polymer (B1), 17.5 g of the sol-gel hydrolysis composition (A1), and 16.0 g of SOLMIX AP-1 were put and stirred at 25° C. for 10 minutes to obtain a coating solution 2 as an antifogging agent composition. An antifogging article having an antifogging layer was obtained in a similar manner to Example 1 except using the coating solution 2 instead of the coating solution 1.

### Example 3

In a glass container in which a stirrer and a thermometer were set, 63.0 g of the highly water-absorbing resin pre-polymer (B1), 35.0 g of the sol-gel hydrolysis composition (A1), and 2.0 g of SOLMIX AP-1 were put and stirred at 25° C. for 10 minutes to obtain a coating solution 3 as an antifogging agent composition. An antifogging article having an antifogging layer was obtained in the similar manner to Example 1 except using the coating solution 3 instead of the coating solution 1.

### Example 4

In a glass container in which a stirrer and a thermometer were set, 37.5 g of the highly water-absorbing resin pre-polymer (B1) and 62.5 g of the sol-gel hydrolysis composition (A1) were put and stirred at 25° C. for 10 minutes to obtain a coating solution 4 as an antifogging agent composition. An antifogging article having an antifogging layer was obtained in the similar manner to Example 1 except using the coating solution 4 instead of the coating solution 1.

### Example 5

In a glass container in which a stirrer and a thermometer were set, 67.8 g of the highly water-absorbing resin pre-polymer (B1), 17.9 g of the sol-gel hydrolysis composition (A2), and 14.3 g of SOLMIX AP-1 were put and stirred at 25° C. for 10 minutes to obtain a coating solution 5 as an antifogging agent composition. An antifogging article having an antifogging layer was obtained in the similar manner to Example 1 except using the coating solution 5 instead of the coating solution 1.

### Example 6

In a glass container in which a stirrer and a thermometer were set, 64.3 g of the highly water-absorbing resin pre-polymer (B1), 35.7 g of the sol-gel hydrolysis composition (A2), and 0.1 g of SOLMIX AP-1 were put and stirred at 25° C. for 10 minutes to obtain a coating solution 6 as an antifogging agent composition. An antifogging article having an antifogging layer was obtained in the similar manner to Example 1 except using the coating solution 6 instead of the coating solution 1.

### Example 7

In a glass container in which a stirrer and a thermometer were set, 37.5 g of the highly water-absorbing resin pre-polymer (B1) and 62.5 g of the sol-gel hydrolysis composition (A2) were put and stirred at 25° C. for 10 minutes to obtain a coating solution 7 as an antifogging agent composition. An antifogging article having an antifogging layer was obtained in the similar manner to Example 1 except using the coating solution 7 instead of the coating solution 1.

### Example 8

In a glass container in which a stirrer and a thermometer were set, 63.3 g of the highly water-absorbing resin pre-polymer (B1), 15.8 g of the lowly water-absorbing resin pre-polymer (C1), and 20.8 g of the sol-gel hydrolysis composition (A1) were put and stirred at 25° C. for 10 minutes to obtain a coating solution 8 as an antifogging agent composition. An antifogging article having an antifogging layer was obtained in the similar manner to Example 1 except using the coating solution 8 instead of the coating solution 1.

### Example 9

In a glass container in which a stirrer and a thermometer were set, 47.5 g of the highly water-absorbing resin pre-polymer (B1), 31.7 g of the lowly water-absorbing resin pre-polymer (C1), and 20.8 g of the sol-gel hydrolysis composition (A1) were put and stirred at 25° C. for 10 minutes to obtain a coating solution 9 as an antifogging agent composition. An antifogging article having an antifogging layer was obtained in the similar manner to Example 1 except using the coating solution 9 instead of the coating solution 1.

### Example 10

In a glass container in which a stirrer and a thermometer were set, 31.7 g of the highly water-absorbing resin pre-polymer (B1), 47.5 g of the lowly water-absorbing resin pre-polymer (C1), and 20.8 g of the sol-gel hydrolysis composition (A1) were put and stirred at 25° C. for 10 minutes to obtain a coating solution 10 as an antifogging agent composition. An antifogging article having an antifogging layer was obtained in the similar manner to Example 1 except using the coating solution 10 instead of the coating solution 1.

### Example 11

In a glass container in which a stirrer and a thermometer were set, 15.8 g of the highly water-absorbing resin pre-polymer (B1), 63.3 g of the lowly water-absorbing resin pre-polymer (C1), and 20.8 g of the sol-gel hydrolysis composition (A1) were put and stirred at 25° C. for 10 minutes to obtain a coating solution 11 as an antifogging agent composition. An antifogging article having an antifogging layer was obtained in the similar manner to Example 1 except using the coating solution 11 instead of the coating solution 1.

### Example 12

In a glass container in which a stirrer and a thermometer were set, 79.2 g of the lowly water-absorbing resin pre-polymer (C1) and 20.8 g of the sol-gel hydrolysis composition (A1) were put and stirred at 25° C. for 10 minutes to obtain a coating solution 12 as an antifogging agent composition. An antifogging article having an antifogging layer was obtained in the similar manner to Example 1 except using the coating solution 12 instead of the coating solution 1.

### Example 13

In a glass container in which a stirrer and a thermometer were set, 63.3 g of the highly water-absorbing resin pre-polymer (B1), 15.8 g of the lowly water-absorbing resin pre-polymer (C2), and 20.8 g of the sol-gel hydrolysis composition (A1) were put and stirred at 25° C. for 10 minutes to obtain a coating solution 13 as an antifogging agent composition. An antifogging article having an antifogging layer was obtained in the similar manner to Example 1 except using the coating solution 13 instead of the coating solution 1.

### Example 14

In a glass container in which a stirrer and a thermometer were set, 47.5 g of the highly water-absorbing resin pre-polymer (B1), 31.7 g of the lowly water-absorbing resin pre-polymer (C2), and 20.8 g of the sol-gel hydrolysis composition (A1) were put and stirred at 25° C. for 10 minutes to obtain a coating solution 14 as an antifogging agent composition. An antifogging article having an antifogging layer was obtained in the similar manner to Example 1 except using the coating solution 14 instead of the coating solution 1.

### Example 15

In a glass container in which a stirrer and a thermometer were set, 31.7 g of the highly water-absorbing resin pre-polymer (B1), 47.5 g of the lowly water-absorbing resin pre-polymer (C2), and 20.8 g of the sol-gel hydrolysis composition (A1) were put and stirred at 25° C. for 10 minutes to obtain a coating solution 15 as an antifogging agent composition. An antifogging article having an antifogging layer was obtained in the similar manner to Example 1 except using the coating solution 15 instead of the coating solution 1.

### Example 16

In a glass container in which a stirrer and a thermometer were set, 15.8 g of the highly water-absorbing resin pre-polymer (B1), 63.3 g of the lowly water-absorbing resin pre-polymer (C2), and 20.8 g of the sol-gel hydrolysis composition (A1) were put and stirred at 25° C. for 10 minutes to obtain a coating solution 16 as an antifogging agent composition. An antifogging article having an antifogging layer was obtained in the similar manner to Example 1 except using the coating solution 16 instead of the coating solution 1.

### Example 17

In a glass container in which a stirrer and a thermometer were set, 79.2 g of the lowly water-absorbing resin pre-polymer (C2) and 20.8 g of the sol-gel hydrolysis composition (A1) were put and stirred at 25° C. for 10 minutes to obtain a coating solution 17 as an antifogging agent composition. An antifogging article having an antifogging layer was obtained in the similar manner to Example 1 except using the coating solution 17 instead of the coating solution 1.

### Example 18

In a glass container in which a stirrer and a thermometer were set, 63.3 g of the highly water-absorbing resin pre-polymer (B1), 15.8 g of the lowly water-absorbing resin pre-polymer (C3), and 20.8 g of the sol-gel hydrolysis composition (A1) were put and stirred at 25° C. for 10 minutes to obtain a coating solution 18 as an antifogging agent composition. An antifogging article having an antifogging layer was obtained in the similar manner to Example 1 except using the coating solution 18 instead of the coating solution 1.

### Example 19

In a glass container in which a stirrer and a thermometer were set, 47.5 g of the highly water-absorbing resin pre-polymer (B1), 31.7 g of the lowly water-absorbing resin pre-polymer (C3), and 20.8 g of the sol-gel hydrolysis composition (A1) were put and stirred at 25° C. for 10 minutes to obtain a coating solution 19 as an antifogging agent composition. An antifogging article having an antifogging layer was obtained in the similar manner to Example 1 except using the coating solution 19 instead of the coating solution 1.

### Example 20

In a glass container in which a stirrer and a thermometer were set, 31.7 g of the highly water-absorbing resin pre-polymer (B1), 47.5 g of the lowly water-absorbing resin pre-polymer (C3), and 20.8 g of the sol-gel hydrolysis composition (A1) were put and stirred at 25° C. for 10 minutes to obtain a coating solution 20 as an antifogging agent composition. An antifogging article having an antifogging layer was obtained in the similar manner to Example 1 except using the coating solution 20 instead of the coating solution 1.

### Example 21

In a glass container in which a stirrer and a thermometer were set, 15.8 g of the highly water-absorbing resin pre-polymer (B1), 63.3 g of the lowly water-absorbing resin pre-polymer (C3), and 20.8 g of the sol-gel hydrolysis composition (A1) were put and stirred at 25° C. for 10 minutes to obtain a coating solution 21 as an antifogging agent composition. An antifogging article having an antifogging layer was obtained in the similar manner to Example 1 except using the coating solution 21 instead of the coating solution 1.

### Example 22

In a glass container in which a stirrer and a thermometer were set, 79.2 g of the highly water-absorbing resin pre-polymer (B2) and 20.8 g of the sol-gel hydrolysis composition (A1) were put and stirred at 25° C. for 10 minutes to obtain a coating solution 22 as an antifogging agent composition. An antifogging article having an antifogging layer was obtained in the similar manner to Example 1 except using the coating solution 22 instead of the coating solution 1.

### Example 23

In a glass container in which a stirrer and a thermometer were set, 63.3 g of the highly water-absorbing resin pre-polymer (B2), 15.8 g of the lowly water-absorbing resin pre-polymer (C1), and 20.8 g of the sol-gel hydrolysis composition (A1) were put and stirred at 25° C. for 10 minutes to obtain a coating solution 23 as an antifogging agent composition. An antifogging article having an antifogging layer was obtained in the similar manner to Example 1 except using the coating solution 23 instead of the coating solution 1.

### Example 24

In a glass container in which a stirrer and a thermometer were set, 47.5 g of the highly water-absorbing resin pre-polymer (B2), 31.7 g of the lowly water-absorbing resin pre-polymer (C1), and 20.8 g of the sol-gel hydrolysis composition (A1) were put and stirred at 25° C. for 10 minutes to obtain a coating solution 24 as an antifogging agent composition. An antifogging article having an antifogging layer was obtained in the similar manner to Example 1 except using the coating solution 24 instead of the coating solution 1.

### Example 25

In a glass container in which a stirrer and a thermometer were set, 31.7 g of the highly water-absorbing resin pre-polymer (B2), 47.5 g of the lowly water-absorbing resin pre-polymer (C1), and 20.8 g of the sol-gel hydrolysis composition (A1) were put and stirred at 25° C. for 10 minutes to obtain a coating solution 25 as an antifogging agent composition. An antifogging article having an antifogging layer was obtained in the similar manner to Example 1 except using the coating solution 25 instead of the coating solution 1.

### Example 26

In a glass container in which a stirrer and a thermometer were set, 10.1 g of SOLMIX AP-1, 38.9 g of EX1610, 11.0 g of the sol-gel hydrolysis composition (A1), and 40.0 g of the curing agent dilution (D) were put and stirred at 25° C. for 30 minutes to obtain a coating solution 26 as an antifogging agent composition. An antifogging article having an antifogging layer was obtained in the similar manner to Example 1 except using the coating solution 26 instead of the coating solution 1.

### Example 27

In a glass container in which a stirrer and a thermometer were set, 10.1 g of SOLMIX AP-1, 31.1 g of EX1610, 7.8 g of EP4100, 11.0 g of the sol-gel hydrolysis composition (A1), and 40.0 g of the curing agent dilution (D) were put and stirred at 25° C. for 30 minutes to obtain a coating solution 27 as an antifogging agent composition. An antifogging article having an antifogging layer was obtained in the similar manner to Example 1 except using the coating solution 27 instead of the coating solution 1.

### Example 28

In a glass container in which a stirrer and a thermometer were set, 10.1 g of SOLMIX AP-1, 23.3 g of EX1610, 15.6 g of EP4100, 11.0 g of the sol-gel hydrolysis composition (A1), and 40.0 g of the curing agent dilution (D) were put and stirred at 25° C. for 30 minutes to obtain a coating solution 28 as an antifogging agent composition. An antifogging article having an antifogging layer was obtained in the similar manner to Example 1 except using the coating solution 28 instead of the coating solution 1.

### Example 29

In a glass container in which a stirrer and a thermometer were set, 10.1 g of SOLMIX AP-1, 15.6 g of EX1610, 23.3 g of EP4100, 11.0 g of the sol-gel hydrolysis composition (A1), and 40.0 g of the curing agent dilution (D) were put and stirred at 25° C. for 30 minutes to obtain a coating solution 29 as an antifogging agent composition. An antifogging article having an antifogging layer was obtained in the similar manner to Example 1 except using the coating solution 29 instead of the coating solution 1.

### Example 30

In a glass container in which a stirrer and a thermometer were set, 10.1 g of SOLMIX AP-1, 7.8 g of EX1610, 31.1 g of EP4100, 11.0 g of the sol-gel hydrolysis composition (A1), and 40.0 g of the curing agent dilution (D) were put and stirred at 25° C. for 30 minutes to obtain a coating solution 30 as an antifogging agent composition. An antifogging article having an antifogging layer was obtained in the similar manner to Example 1 except using the coating solution 30 instead of the coating solution 1.

### Example 31

In a glass container in which a stirrer and a thermometer were set, 10.1 g of SOLMIX AP-1, 38.9 g of EP4100, 11.0 g of the sol-gel hydrolysis composition (A1), and 40.0 g of the curing agent dilution (D) were put and stirred at 25° C. for 30 minutes to obtain a coating solution 31 as an antifogging agent composition. An antifogging article having an antifogging layer was obtained in the similar manner to Example 1 except using the coating solution 31 instead of the coating solution 1.

Table 1 presents solid content compositions (mass %) of the coating solutions 1 to 31 as the antifogging agent compositions obtained in the above-described respective examples and film thicknesses of the obtained antifogging layers. Further, the evaluation results of the antifogging articles obtained in the respective examples are summarized in Table 2.

TABLE 1

| | | Highly water- | | Lowly water- | | | | | | | |
|---|---|---|---|---|---|---|---|---|---|---|---|
| Example | Film thickness | soluble resin | | soluble resin | | | Curing agent | | | Alkoxysilane compound | |
| Number | [μm] | EX1610 | EX614B | EP4100 | EX622 | EX612 | NH₄ClO₄ | Al(acac)₃ | TMP-30 | TEOS | GPTMS |
| 1 | 20.0 | 79.1 | | | | | 0.3 | | 20.6 | | |
| 2 | 19.5 | 67.9 | | | | | 0.3 | | 17.7 | | 14.1 |
| 3 | 23.1 | 58.8 | | | | | 0.2 | | 15.3 | | 25.7 |
| 4 | 18.5 | 38.9 | | | | | 0.1 | | 10.1 | | 50.9 |
| 5 | 16.5 | 69.1 | | | | | 0.3 | | 18.0 | 12.6 | |
| 6 | 18.4 | 60.5 | | | | | 0.3 | | 15.8 | 23.4 | |
| 7 | 18.3 | 41.3 | | | | | 0.2 | | 10.7 | 47.8 | |
| 8 | 18.4 | 54.6 | | 13.6 | | | 0.3 | | 17.4 | | 14.1 |
| 9 | 18.9 | 41.0 | | 27.4 | | | 0.3 | | 17.1 | | 14.2 |
| 10 | 19.1 | 27.5 | | 41.2 | | | 0.3 | | 16.8 | | 14.2 |
| 11 | 20.0 | 13.5 | | 55.3 | | | 0.3 | | 16.6 | | 14.3 |
| 12 | 17.5 | | | 69.2 | | | 0.3 | | 16.2 | | 14.3 |
| 13 | 182 | 54.6 | | | 13.6 | | 0.3 | | 17.4 | | 14.1 |
| 14 | 18.2 | 41.0 | | | 27.4 | | 0.3 | | 17.1 | | 14.2 |
| 15 | 18.2 | 27.5 | | | 41.3 | | 0.3 | | 16.7 | | 14.2 |
| 16 | 18.2 | 13.8 | | | 55.2 | | 0.3 | | 16.4 | | 14.3 |
| 17 | 18.2 | | | | 69.3 | | 0.3 | | 16.1 | | 14.3 |
| 18 | 18.7 | 54.3 | | | | 13.6 | 0.3 | | 17.8 | | 14.0 |
| 19 | 19.5 | 40.7 | | | | 27.1 | 0.3 | | 17.9 | | 14.0 |
| 20 | 18.5 | 27.1 | | | | 40.7 | 0.3 | | 17.9 | | 14.0 |
| 21 | 20.0 | 13.5 | | | | 54.2 | 0.3 | | 18.0 | | 14.0 |
| 22 | 21.2 | | 68.1 | | | | 0.3 | | 17.5 | | 14.1 |
| 23 | 18.8 | | 54.7 | 13.7 | | | 0.3 | | 17.2 | | 14.1 |
| 24 | 19.1 | | 41.2 | 27.5 | | | 0.3 | | 16.9 | | 14.1 |
| 25 | 20.0 | | 27.5 | 41.3 | | | 0.3 | | 16.7 | | 14.2 |
| 26 | 18.5 | 87.6 | | | | | | 2.7 | | | 9.7 |
| 27 | 19.2 | 70.1 | | 17.5 | | | | 2.7 | | | 9.7 |
| 28 | 20.1 | 52.5 | | 35.1 | | | | 2.7 | | | 9.7 |
| 29 | 18.8 | 35.1 | | 52.5 | | | | 2.7 | | | 9.7 |
| 30 | 17.5 | 17.5 | | 70.1 | | | | 2.7 | | | 9.7 |
| 31 | 18.2 | | | 87.6 | | | | 2.7 | | | 9.7 |

TABLE 2

| | | | | Abrasion |
|---|---|---|---|---|
| Example | Antifogging | Cold-wet-hot | | resistance |
| Number | property (second) | cycle | Adhesiveness | ΔH (%) |
| 1 | 140 | 6 | 0/100 | 5.6 |
| 2 | 120 | 11 | 100/100 | 4.8 |
| 3 | 100 | 17 | 100/100 | 3.3 |
| 4 | 80 | 38 | 100/100 | 2.8 |
| 5 | 120 | 12 | 100/100 | 4.8 |
| 6 | 100 | 12 | 100/100 | 3.3 |
| 7 | 80 | 30 | 100/100 | 2.8 |
| 8 | 100 | 250 | 100/100 | 3.5 |
| 9 | 80 | 300 | 100/100 | 3.3 |
| 10 | 60 | 350 | 100/100 | 2.8 |
| 11 | 40 | 450 | 100/100 | 3.3 |
| 12 | 20 | 450 | 100/100 | 3.2 |
| 13 | 100 | 100 | 100/100 | 3.4 |
| 14 | 80 | 120 | 100/100 | 3.7 |
| 15 | 60 | 200 | 100/100 | 3.5 |
| 16 | 40 | 250 | 100/100 | 3.8 |
| 17 | 20 | 450 | 100/100 | 3.1 |
| 18 | 100 | 80 | 100/100 | 3.8 |
| 19 | 80 | 100 | 100/100 | 3.2 |
| 20 | 60 | 150 | 100/100 | 3.6 |
| 21 | 40 | 300 | 100/100 | 3.9 |
| 22 | 100 | 20 | 100/100 | 3.2 |
| 23 | 80 | 200 | 100/100 | 3.5 |
| 24 | 60 | 300 | 100/100 | 3.6 |
| 25 | 40 | 350 | 100/100 | 3.8 |
| 26 | 140 | 11 | 100/100 | 2.3 |
| 27 | 100 | 100 | 100/100 | 2.4 |
| 28 | 80 | 120 | 100/100 | 2.6 |
| 29 | 60 | 200 | 100/100 | 2.4 |
| 30 | 40 | 350 | 100/100 | 2.5 |
| 31 | 20 | 450 | 100/100 | 2.7 |

As presented by Table 2, it is found that the antifogging articles of Examples 8 to 11, 13 to 16, 18 to 21, 23 to 25, and 27 to 30 which are the examples have excellent antifogging property and are excellent in peel resistance (cold-wet-hot cycle property). Further, it is found that the antifogging article of each example of the examples has practical abrasion resistance and sufficient adhesiveness. On the other hand, the antifogging articles of Examples 1 to 7, 12, 17, 22, 26, and 31 of the comparative examples have each the antifogging layer formed using the antifogging agent composition containing only any one of the highly water-soluble resin and the lowly water-soluble resin. In Example 1 to Example 7, Example 22, and Example 26 in which the lowly water-soluble resin is not contained, in particular the antifogging articles do not each have the sufficient cold-wet-hot cycle property. In Example 12, Example 17, and Example 31 in which the highly water-soluble resin is not contained, the antifogging articles do not each have the sufficient antifogging property.

An antifogging agent composition of the present invention is useful for obtaining an antifogging article since excellent antifogging property and peel resistance are given to an antifogging layer. The antifogging article obtained using the antifogging agent composition of the present invention is useful as a window glass for transportation equipment (automobile, railway vehicle, boat, aircraft, and the like), a refrigerated display case, a dressing table mirror, a bathroom mirror, an optical apparatus, and the like.

What is claim is:

1. An antifogging agent composition comprising:
a first resin having a water-soluble rate of 90% or more;
a second resin having a water-soluble rate of 50% or less;
an alkoxysilane compound; and
a curing agent,
wherein the first resin having the water-soluble rate of 90% or more is a polyfunctional aliphatic epoxy resin, and
the second resin having the water-soluble rate of 50% or less is a polyfunctional aromatic epoxy resin having a water-soluble rate of less than 20%.

2. The antifogging agent composition according to claim 1,
wherein the alkoxysilane compound is a compound represented by the following general formula (I),
(R¹O)ₚSiR²₍₄₋ₚ₎ (I)
where each R¹ independently represents an alkyl group having 1 to 4 carbon atoms, each R² independently represents an alkyl group having 1 to 10 carbon atoms, which may have a substituent, and p represents the number of 1 to 4.

3. The antifogging agent composition according to claim 1,
wherein relative to total 100 parts by mass of the first resin having the water-soluble rate of 90% or more and the second resin having the water-soluble rate of 50% or less, the first resin having the water-soluble rate of 90% or more is 10 to 90 parts by mass and the second resin having the water-soluble rate of 50% or less is 90 to 10 parts by mass.

4. An antifogging article comprising:
a substrate; and
a cured product of the antifogging agent composition according to claim 1, disposed in at least a part of a region on the substrate.

5. A manufacturing method of an antifogging article, the method comprising:
forming an antifogging agent composition layer by applying the antifogging agent composition according to claim 1 on a substrate; and
forming an antifogging layer by heat-treating the applied antifogging agent composition.
